(19) United States
(12) Patent Application Publication
(10) Pub. No.: US 2002/0179544 A1
(43) Pub. Date: Dec. 5, 2002

(54) Cell processing and fluid transfer apparatus and method of use

(75) Inventors: Craig Johnson, Mission Viejo, CA (US); Rena Juliar, Corona, CA (US); Lance Noller, Yorba Linda, CA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Nexell Therapeutics, Inc.

(21) Appl. No.: 10/136,747

(22) Filed: Apr. 29, 2002

Related U.S. Application Data
(60) Provisional application No. 60/287,107, filed on Apr. 27, 2001.

(51) Int. Cl. B01D 21/26; B01D 21/00

(52) U.S. Cl. 210/806; 210/804; 210/739; 494/37

(57) ABSTRACT

An apparatus and method of use are disclosed to automatically process and transfer fluids. The apparatus may include a user-interface, clamps, pumps, spinning membranes, pressure transducers, fluid detectors, solution towers, weight scales and tubing sets to control and monitor cell washing, concentrating and harvesting procedures. In addition, the apparatus may also be used to control and monitor a variety of fluid transfer procedures. The apparatus may also be used to execute default or user-defined cell washing and fluid transfer procedures.

### CROSS REFERENCE TO RELATED APPLICATIONS

The present application claims priority to U.S. Provisional Patent Application No. 60/287,107, filed Apr. 27, 2001, whose contents are fully incorporated herein by reference.

### BACKGROUND OF THE INVENTION

Cellular therapies may be used to treat cancer, mitigate the side-effects of aggressive cancer treatments, address genetic defects and remedy a variety of other diseases and disorders. Examples of cellular therapies include, but are not limited to, stem cell therapy, cord blood therapy, dendritic cell therapy, T cell therapy, vaccine therapy and gene therapy. The advent of cellular and blood component therapy has given rise to various technologies designed for blood component or cellular manipulation, such as separating, washing, concentrating, expanding, transferring and collecting specific blood components or cells. The manipulation of cellular products is generally termed cell processing.

One example of cell processing is a cell culture. Cell culture is a broad term that is defined as the maintenance or cultivation of cells in vitro. During a culture process, cells can be differentiated, expanded, manipulated or preferentially selected. These processes generally require the addition or removal of reagents or media to and from the culture. In order to accomplish this, cell washing, cell concentration, cell harvesting and fluid manipulation may be required.

In general, cells are washed to remove undesired components and to replace them with new (fresh) or different fluids. This process results in a concentration of the desired cells by removing the fluid component of the cell solution. The fluid usually contains the unwanted or excess material that is being removed. Components that are removed include spent media, dead cells, cellular debris, blood components (e.g., red cells, plasma, platelets), proteins, cytokines, antibodies, anticoagulants, cryoprotectants, excess peptides, and antigens.

Cell washing is done in processes that range from small to large scale. Smallscale washing is typically performed by centrifugation. A small-scale washing process (e.g., volumes ranging from 5 mL to 1 liter) generally entails collecting cells from a container, such as a tissue culture flask, roller bottle, small bioreactor or culture bag, and transferring the cells to conical centrifuge tubes.

Washing of cells in the medium range (e.g., 1 to 10 liters) is often difficult compared to small-scale washing processes. In order to perform a medium-scale washing, the cells are typically transferred to several 250 mL conical centrifuge tubes, which are the largest size of tubes that will fit into a standard, floor model centrifuge. As such, washing a 5 liter culture, for example, would require twenty of these tubes. Further, since a centrifuge will only hold four tubes at a time, a technician would have to perform, at a minimum, five centrifugations for each wash, since most cell processes require multiple washes.

For both small-scale and medium-scale washing processes, the standard method of transferring or harvesting cells from tissue culture flasks to conical centrifuge tubes involves the use of pipettes. Cells contained in culture bags are transferred to centrifuge tubes by using a sterile syringe connected to a needle or by gravity draining through tubing directly into the centrifuge tubes. These transfers must be performed in a sterile, laminar flow hood to prevent contamination of the cells and exposure to the technician. Once the culture has been transferred to the centrifuge tubes, the tubes are placed in a centrifuge and spun at a predetermined speed for a desired length of time. Alternatively, cells grown in culture bags may be centrifuged in the culture bags themselves, depending on the manufacturers' recommendations and on the requirements of the particular institution. The culture is centrifuged in order to separate the desired cell components from the cell suspension or supernatant.

Each centrifugation takes approximately thirty minutes or a total of two and a half hours per wash. After each centrifugation, the supernatant is removed from the concentration of desired cells. If the culture was centrifuged in centrifuge tubes, the supernatant is removed either by using a pipette or by decanting. If the culture was centrifuged in a bag, the supernatant is removed by gravity draining or aspirating with a syringe or expressed by applying a positive pressure to the bag. As such, each fluid transfer or manipulation increases the risk of contamination to the cell culture and exposure to the technician. Moreover, both small-scale and medium-scale washing processes are labor intensive and prone to human error.

Unlike the previously described manual small-scale and medium-scale washing processes, large-scale washing processes (e.g., volumes greater than 10 liters) are typically performed using automated cell washing or harvesting devices. Although conventional, automated devices generally reduce the risk of contamination to the cell culture and exposure to the technician, these devices have difficulty maintaining a closed system during recovery of the cell product and have low cell recovery of the product at the end of the process or procedure. Further, conventional automated cell-washing devices are expensive, complicated to use and maintain, and, due to their size, typically require a large amount of laboratory floor-space.

In general, cell washing and other cell processing procedures require extensive fluid manipulation whereby fluids are transferred to and from various containers. For example, cell culture media can be taken from one container and added to another to initiate a new cell culture or to feed an existing one. Furthermore, cultures can be adjusted to optimal concentrations by dividing the contents into additional culture containers after which fresh media may be added to continue the cultures. Addition of reagents, such as growth factors, media supplements and diluents are further examples of fluid manipulation. Similarly, the addition of washing buffers and diluents for other cell processes, such as the preparation of cryoprotectant prior to freezing blood products, also require fluid transfer.

Traditionally, fluid manipulation is a very slow and cumbersome process. For example, culture media is usually added to tubes or other types of containers using a pipette. This becomes a concern when dealing with large volumes due to the number of times the technician is required to fill and empty the pipette. Not only is this process time consuming, but also it is an open system that is highly susceptible to contamination. Moreover, the quality of results obtained from the fluid manipulation depends greatly on the skill of the technician and, as a result, may not be as repeatable as desired.

When cell culture bags or large volume containers are used, fluids are transferred using syringes connected either to needles or to tubing lines attached to the bags. Large volume transfers using syringes are difficult since the largest, available syringe is typically only 60cc. As such, multiple transfers are required which not only increase the risk of contamination to the culture bags, but also increase error potential and processing costs.

In view of the above, there is a need for an improved and simplified cell processing device and method of use. In particular, it is desirable that the device includes efficient cell washing and fluid transfer capabilities with low cell loss and high cell viability. The device should also provide a closed system fluid path that reduces the risk of contamination to the cells and increases user or technician safety during cell processing procedures. Furthermore, the device and its related methods should accommodate a variety of cell processing techniques, provide flexible, multi-user platforms for cell processing procedures and automate many of the labor-intensive cell-processing tasks. In addition, the device should be relatively small in size, inexpensive and easy to operate.

### BRIEF SUMMARY OF THE INVENTION

In general, the present invention contemplates an automated method of processing particles in a fluid comprising entering one or more operations into an automated processing device. The operations may include separating discrete particles in a suspension from a suspending fluid based on particle size; washing said particles by concentration of said particles, removal of the fluid and resuspension in a second fluid; mixing a particle suspension; selectively adding and/or removing a secondary suspension from and to multiple integral containers; and/or pausing operations. The method also includes receiving processing information from the automated device. In general, the operations may be performed in any order or sequence, providing improved versatility of the fluid path or fluid flow circuit. The method may also include selecting a program to control performance of said operations, creating a user-defined program to control performance of said operations, editing said program to include user-defined operations, and/or editing said program to include user-defined parameters.

The present invention also contemplates an automated fluid transfer device comprising a pump module; and a disposable, sterile tubing set, said tubing set configurable on said pump module in a first configuration and said tubing set configurable on said pump module in a second configuration, wherein said second configuration is achieved by rotating said first configuration 180 degrees. The tubing set of the device may also include a first end having a single source line and a second end having multiple destination lines, a first end having multiple source lines and a second end having a single destination line, and/or a first end having multiple source lines and a second end having multiple destination lines.

### BRIEF DESCRIPTION OF THE DRAWINGS

Other features and advantages of the present invention will be seen as the following description of particular embodiments progresses in conjunction with the drawings, in which:

FIG. 1 is a perspective view of a cell processing and fluid transfer device in accordance with an embodiment of the present invention;

FIG. 2A is a perspective view of a cell processing and fluid transfer device in accordance with an embodiment of the present invention;

FIG. 2B illustrates a cell washer tubing set in accordance with an embodiment of the present invention;

FIG. 3A is a perspective view a cell processing and fluid transfer device in accordance with an embodiment of the present invention;

FIG. 3B illustrates a fluid transfer tubing set in accordance with an embodiment of the present invention;

FIG. 4A illustrates one embodiment of an adapter set of the present invention;

FIG. 4B illustrates another embodiment of an adapter set of the present invention;

FIG. 5 illustrates an active state display screen in accordance with an embodiment of the present invention;

FIG. 6 illustrates a menu display screen in accordance with an embodiment of the present invention;

FIG. 7 illustrates a device status display screen in accordance with an embodiment of the present invention;

FIG. 8 illustrates a system info display screen in accordance with an embodiment of the present invention;

FIG. 9 illustrates a stop pressed display screen in accordance with an embodiment of the present invention;

FIGS. 10A-10K illustrate a variety of screens displayed on the device in accordance with an embodiment of the present invention;

FIG. 11 illustrates a fluid flow circuit diagram in accordance with an embodiment of the present invention;

FIG. 12 illustrates a fluid flow circuit diagram in accordance with an embodiment of the present invention;

FIG. 13 illustrates a fluid flow circuit diagrams in accordance with an embodiment of the present invention;

FIGS. 14A and 14B illustrate fluid flow circuit diagrams in accordance with an embodiment of the present invention;

FIG. 15 illustrates a flowchart of operations in accordance with an embodiment of the present invention;

FIG. 16 illustrates a fluid flow circuit diagram in accordance with an embodiment of the present invention;

FIG. 17 illustrates a fluid flow circuit diagram in accordance with an embodiment of the present invention;

FIG. 18 illustrates a fluid flow circuit diagram in accordance with an embodiment of the present invention; and

FIGS. 19A and 19B illustrate fluid transfer tubing sets in accordance with an embodiment of the present invention.

### DETAILED DESCRIPTION OF THE INVENTION

The following description and figures are meant to be illustrative only and not limiting. Other embodiments of this invention will be apparent to those of ordinary skill in the art in view of this description.

### Cell Processing and Fluid Transfer Apparatus

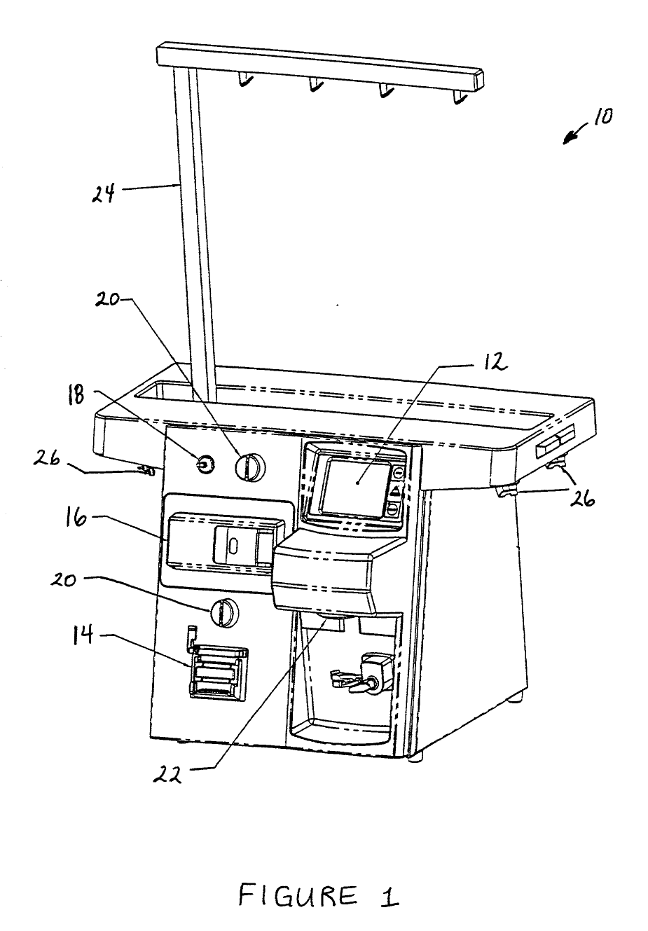

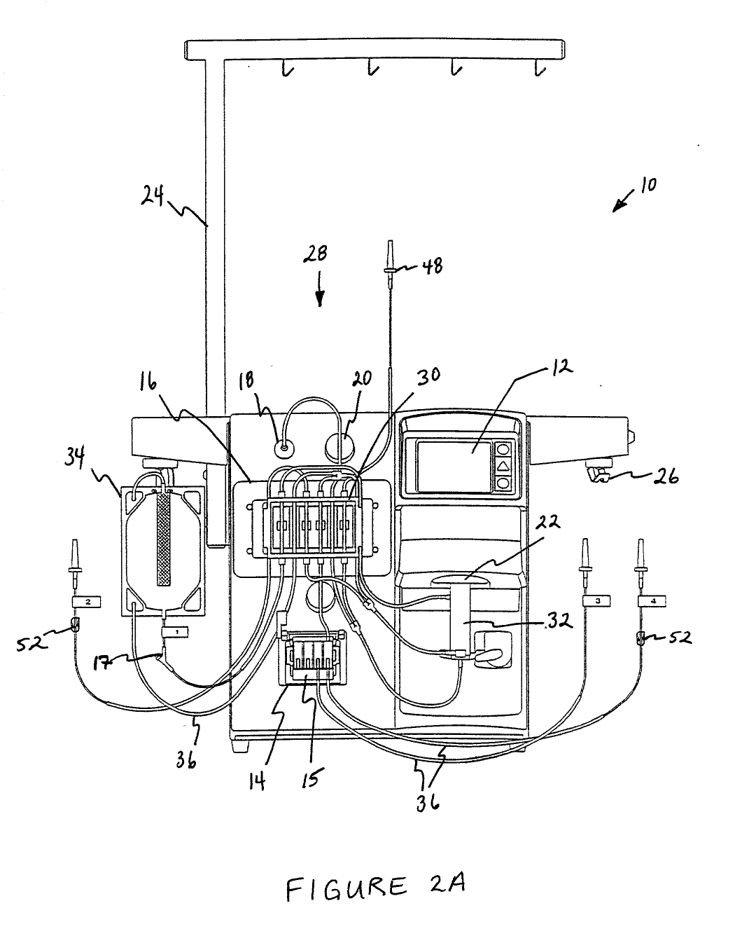

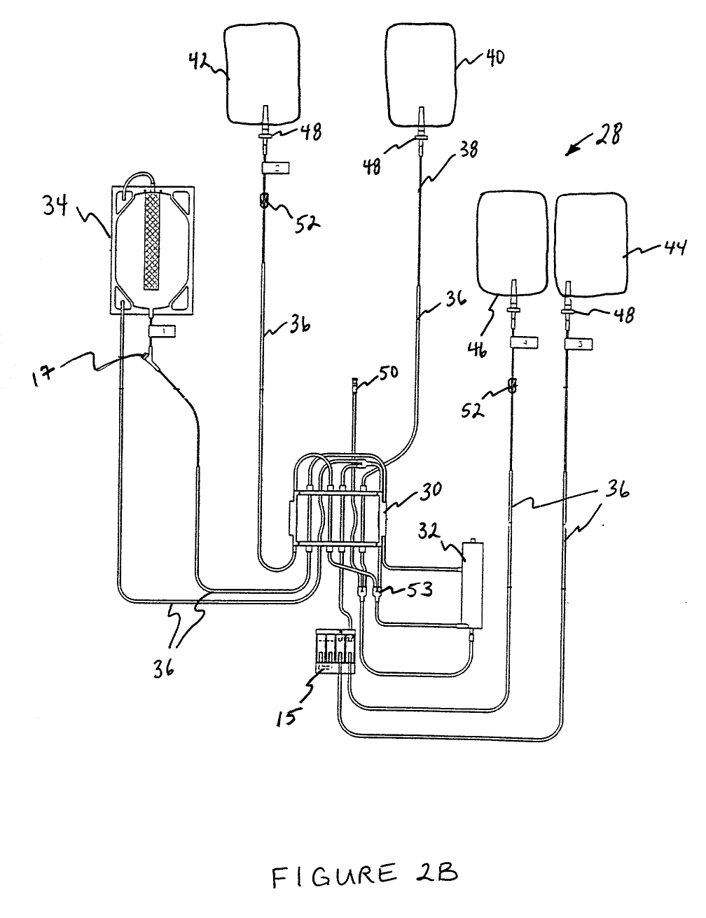

Referring to FIGS. 1 and 2A, an embodiment of the cell processing and fluid transfer device 10 in accordance with the present invention includes a user interface module 12, clamp module 14, pump module 16, pressure transducer 18, fluid detectors 20, spinner module 22, solution towers 24, weight scales 26 and cell washer tubing set 28. Although the device 10 depicted in FIG. 2A includes a cell washer tubing set 28, it is understood that other fluid transfer tubing sets may also be used with the device 10 of the present invention. Each of these modules and related components of the device 10 perform a variety of operations and maintains communication with the other modules and components via a system control module (not shown) to ensure proper functioning of the device 10.

The cell processing and fluid transfer device 10 of the present invention may also include a data port (not shown). Examples of such a data port include, but are not limited to, RS232, RS422 and RS485 ports. The data port may be used to transmit and/or receive various communication signals, such as program files, data files, error reports, records of run execution and performance and other types of system information. The information, for example program files which may be recorded on the device 10 or transmitted real-time, may be transferred as files to a PC platform or other appropriate system. These systems may be used, for example, to modify files, design new programs, or archive as records that can be used with the device 10 of the present invention.

As illustrated in FIGS. 1 and 2A, the cell processing and fluid transfer device 10 includes an intuitive, menu-driven, Graphical User Interface (GUI) module 12. In one embodiment, the user interface module 12 includes a graphical LCD display/touch screen and a keypad. The graphical configuration of the user interface module 12 enables all instrument features to be accessed by simply touching on-screen buttons, thereby reducing operator error and providing greater operator ease of use. Alternatively, the module 12 may also include a command line driven user interface, a combination of a graphical and command line driven user interface, or other user interface configurations known to those skilled in the art and, thereby, included within the scope of the presently claimed invention.

The display of the user interface module 12 aids users of the device 10 to visualize system functions/operations and user-selectable options/device parameters that are presented in menu format. The various operations and options are displayed in pictorial and/or text format. Alternate embodiments of the user interface module 12 including, but not limited to, various combinations of display screens, touch screens, keypads, remote control units and/or voice activated/controlled modules are also included within the scope of the present invention. The user may enter control settings, edit command signals to control fluid flow rates and fluid paths, and monitor the operational states of the device 10 via the user interface module 12.

The clamp module 14 of the cell processing and fluid transfer device 10 includes one or more clamps and is designed to hold a clamp manifold 15 of the tubing set 28. The clamps control the routing of fluid through the various fluid paths of the device 10. In one embodiment, the clamp module 14 provides individual control for up to four clamp solenoids (not shown). However, additional clamp solenoids, preferably one or more, may also be controlled by the clamp module 14 of the present invention. In general, the clamps control fluid flow by compressing and releasing the flexible tubing located between the solenoids and the clamp manifold 15. For example, when the clamps are closed, a portion of tubing is compressed or pinched by the clamp solenoids. As a result, fluid flow is restricted or halted through that particular segment of tubing until the clamp solenoids are opened and the tubing portion released.

Adjacent to the clamp module 14 is the pump module 16. The pump module 16 houses one or more pumps that move fluid through the different fluid paths of the cell processing and fluid transfer device 10. In one embodiment, the pump module 16 comprises four, rotary peristaltic pumps that may operate in forward pumping and reverse pumping directions. A pump organizer or frame 30 positions the tubing over the pumps to facilitate installation and tensions over the peristaltic pump rollers. Other types of pumps including, but not limited to, hydraulic pumps, pneumatic pumps, diaphragm pumps, and gear pumps, may also be used with the device 10 of the present invention. Each pump of the pump module 16 may operate alone or in combination with the other pumps. In addition, the pumping rate and fluid flow rate for each pump may be driven at different speeds and individually controlled, thereby providing increased fluid transfer flexibility to users of the device.

One or more pressure transducers 18 and fluid detectors 20 may also be used to control and monitor fluid pressure and fluid levels on the cell processing and fluid transfer device 10. Examples of fluid states monitored and controlled by these components include, but are not limited to, flow rates, bubbles, air gaps and fluid volume. The pressure transducer 18 and fluid detectors 20 may be positioned at various locations along the tubing and fluid paths of the device. In one embodiment, shown in FIGS. 1 and 2A, a first fluid detector 20 is located adjacent to a pressure transducer 18 and above the pump module 16 and a second fluid detector 20 is located between the pump module 16 and the clamp module 14.

A spinner module 22 is also located adjacent the clamp and pump modules 14,16 of the device 10 of the present invention. The spinner module 22 supports and spins one or more spinning membrane elements 32 of the cell washer tubing set 28. In one embodiment, a magnetic motor housed within the spinner module 22 drives a rotor within the spinning membrane assembly 32. The spinning membrane element 32 is used to wash and concentrate desired cell products from various fluids or cell suspensions. In general, the spinning membrane 32 separates cells and cell products according to their differing sizes.

The cell processing and fluid transfer device 10 may also include a solution tower 24 and weight scales 26. As shown in FIGS. 1 and 2A, the solution tower 24 and weight scales 26 include hangers or hooks used to support the solution containers that are in fluid communication with the cell washer tubing set 28. The solution tower 24 provides general support for the fluid containers, whereas the weight scales 26 of the device 10 monitor the weight change of the containers, thereby indicating fluid flow into and out of the fluid containers. In one embodiment, the maximum allowable weight on the tower 24 is not to exceed twenty kilograms and the maximum allowable weight on each weight scale 26 is not to exceed seven-thousand grams. However, alternate embodiments of the tower 24 and weight scales 26 include, but are not limited to, towers 24 that support weights in excess of twenty kilograms, weight scales 26 that support weights in excess of seven-thousand grams and stand-alone holders that are separate from the device 10 of the present invention. These and other embodiments of the solution tower 24 and weight scales 26 known to those skilled in the art are also included within the scope of the claimed invention.

Referring to FIGS. 2A and 2B, one embodiment of the cell washer tubing set 28 of the present invention includes a spinning membrane 32, filtered wash bag 34, clamp manifold 15, pump frame 30 and tubing 36. As previously described, the spinning membrane assembly 32, which functions as the system's filter, is an integral part of the cell washing and concentrating process. Another key component of the washing and concentrating process is the filtered wash bag 34. During washing procedures, the cell suspension to be washed is contained in the filtered wash bag 34 and flows through the various fluid paths provided by the tubing 36 of the tubing set 28. Although the wash container 34 illustrated in FIGS. 2A and 2B is a bag, a variety of fluid containers well known in the art may also be used with the device 10 of the present invention.

As shown in FIG. 2B, the cell washer tubing set 28 includes an organized maze of tubing or fluid lines 36 that enable various fluids to flow throughout the fluid circuit of the system. In addition to the supernatant (e.g., fluid component of the cell suspension) line 38 and its associated bag, there are four main lines 36 of the cell washer tubing set 28 that are in fluid communication with the fluid containers or bags of the system. In general, tubing or lines 1, 2, 3 and 4 are in fluid communication with the filtered wash bag 34 (i.e., Bag 1), buffer bag 42 (i.e., Bag 2, generally containing a wash solution), final product bag 44 (i.e., Bag 3) and source bag 46 (i.e., Bag 4), respectively. It should be noted, however, that the configuration of the tubing set 28 and bags illustrated in FIG. 2B is only one embodiment of a cell washer tubing set 28 that may be used with the device 10 of the present invention. Alternate embodiments of tubing set configurations, not specifically described herein but known to those skilled in the art, are also included within the scope of the claimed invention.

Additional components of the cell washer tubing set 28 include, but are not limited to: one or more spike couplers 48, needle access couplers 17 and connectable tubing to provide connections to source/destination bags for access to starting/final products, reagents or final products; a pump frame 30 to facilitate installation of the tubing 36 on the pump module 16; a clamp manifold 15 to facilitate installation of the tubing 36 on the clamp module 14; one or more pressure transducer fittings 50 to provide an aseptic interface to the tubing transducer 18; and, one or more manual clamps 52 to facilitate manual flow control before, during and after the cell processing or fluid transfer procedure.

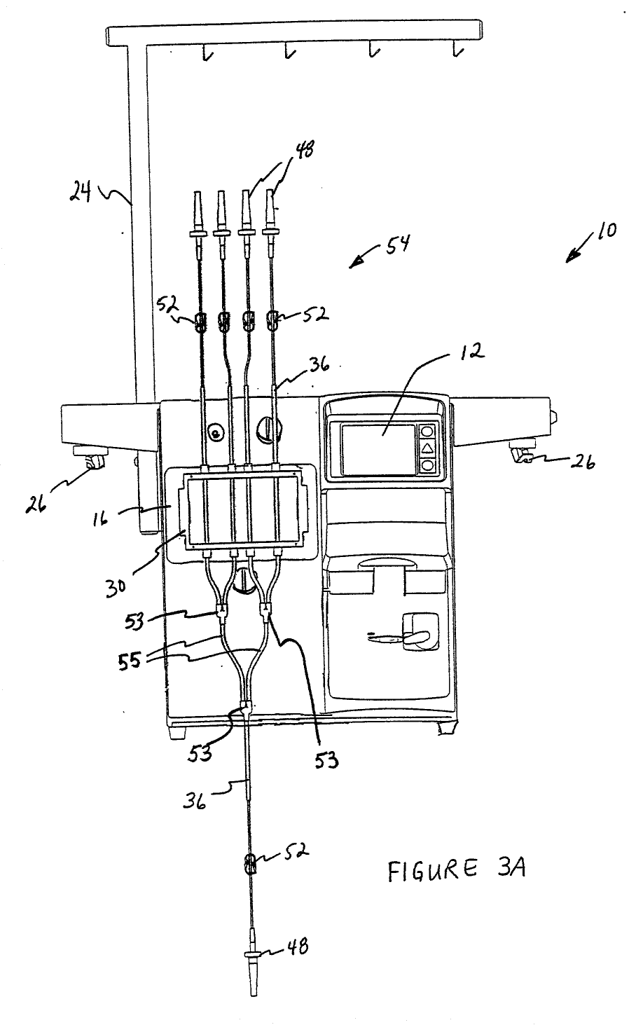

In an alternate embodiment of the invention, a fluid transfer tubing set may also be used with the cell processing and fluid transfer device 10 of the present invention. As illustrated in FIGS. 3A and 3B, one embodiment of the fluid transfer tubing set 54 includes: a first end 56 having one or more source lines/tubing 36; a second end 58 having one or more destination lines/tubing 36; a plurality of spike couplers 48 and connectable tubing for connection to one or more source or destination bags (not shown); a pump tubing organizer 30 to facilitate installation of the tubing 36 on the pump module 16; and one or more manual clamps 52 to facilitate manual flow control before, during and after the cell processing or fluid transfer procedure. The lines/tubing 36 of the first end 56 are in fluid communication with the lines/tubing 36 of the second end 58 of the tubing set 54.

In one embodiment of the tubing set 54, illustrated in FIGS. 3A and 3B, two pairs of the four source lines 36 of the first end 56 of the tubing set 54 are branched together using Y-connectors 53 and tubing segments 55. The two tubing segments 55 are also branched together using a Y-connector 53, thereby forming a single destination line 36 of the second end 58 of the tubing set 54. Although not specifically mentioned herein, alternate tubing set configurations known to those skilled in the art may also be used and, therefore, are within the scope of the present disclosure and claimed invention.

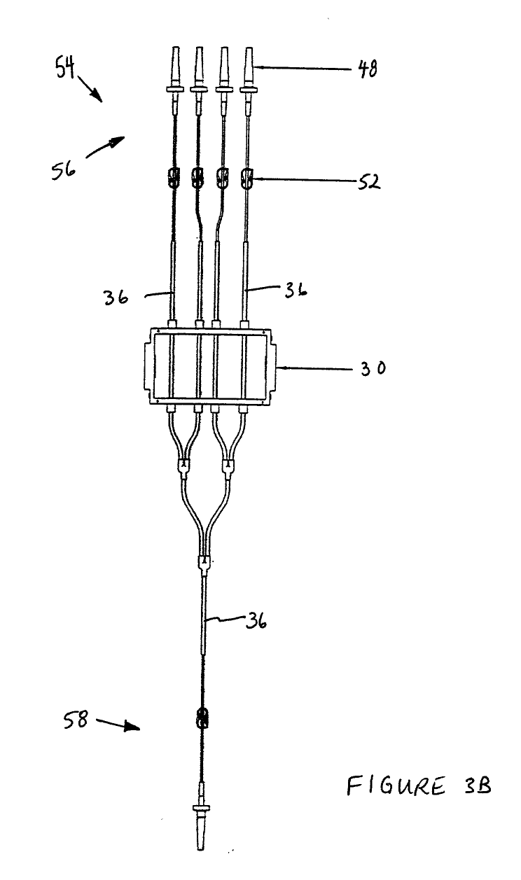

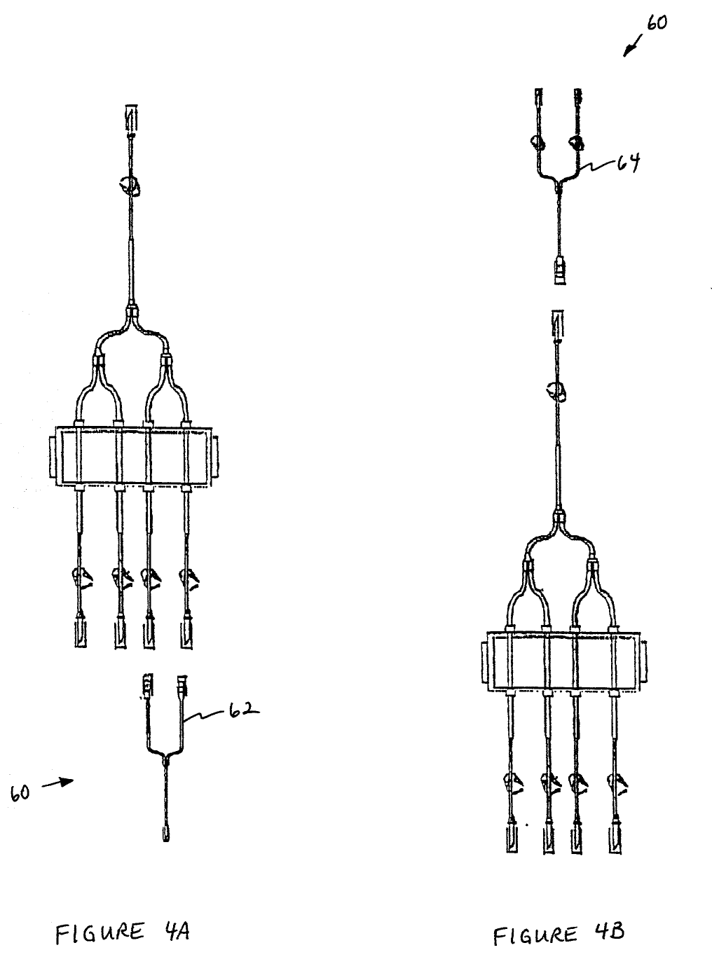

Additional tubing sets, couplers, adapters and other components, known by those skilled in the art, may be used in combination with the cell washer tubing set 28 and fluid transfer tubing set 54 of the present invention. For example, FIGS. 4A and 4B illustrate two embodiments of an adapter set 60 that may be used with the cell washer tubing set 28 and fluid transfer tubing set 54 of the present invention. FIG. 4A shows a two-membrane port to spike adapter set 62 that is used to join, for example, multiple source lines. Alternatively, FIG. 4B shows a two-spike to membrane port adapter set 64 that is used, for example, to connect additional destination lines. Other components not specifically described herein but known to those skilled in the art may also be used to expand a quantity of fluid lines, reduce a quantity of fluid lines or re-direct fluid flow paths in the tubing sets and are included within the scope of the claimed invention.

Both the cell washer tubing set 28 and fluid transfer tubing set 54 of the present invention are sterile, nonpyrogenic, and single-use (i.e., disposable) components. In an alternate embodiment, the tubing sets 28,54 are sterile, nonpyrogenic, and multiple-use (i.e., reusable) components. In yet another embodiment, both disposable and reusable elements are connected together to form the sterile, nonpyrogenic tubing sets 28,54 of the present invention. Overall, the tubing sets 28,54, together with the various fluid containers used with the device of the present invention, provide a sterile, closed, continuous fluid flow circuit through which the various fluids and media may pass. This closed system or fluid flow circuit reduces the risk of contamination to the cells and increases user or technician safety during cell processing or fluid transfer procedures.

As previously described, one embodiment of the cell processing and fluid transfer apparatus includes a graphic LCD display/touch screen and a keypad. This user interface module 12 enables communication signals to be transmitted to and received by the user and the device 10. In general, a variety of screens or menus are available to the user during normal operation of the device 10. Each screen or menu may include one or more buttons which perform different functions, such as returning to a previous menu, advancing to a next menu, accessing other available screens or menus, toggling through selectable parameters or system functions, and editing selectable parameters or system functions. For example, other available screens may be accessed by touching a “state” icon or button located in a corner of each screen. Touching the “state” icon puts the system into a menu mode wherein a menu of available operations, relative to the state or step in the operation from which the “state” button was selected, is displayed. Additional examples of buttons and their functions are further described below. In the spirit of reader convenience and brevity, selectable options are referenced in the text and figures as a ‘button.’ However, it should be noted that other selectable option configurations including, but not limited to, icons, keys, push-buttons, switches, knobs and dials, are also included within the scope of the claimed invention. Examples of representative menus or screens of the present invention are shown in FIGS. 5-10K.

As illustrated in FIG. 5, the “Active State in Progress” screen describes the current active state of the device 10. This screen gives instructions regarding any action required of the user or describes what action is automatically being performed by the system. If an action is required to be completed by the user, the next step or operation in the procedure will not be performed until that action is properly completed. Once an action is completed, the user may select the “OK” button or icon to proceed to the next step in the procedure or process. One embodiment of an “OK” button 65 for the device 10 of the present invention is illustrated in FIG. 5.

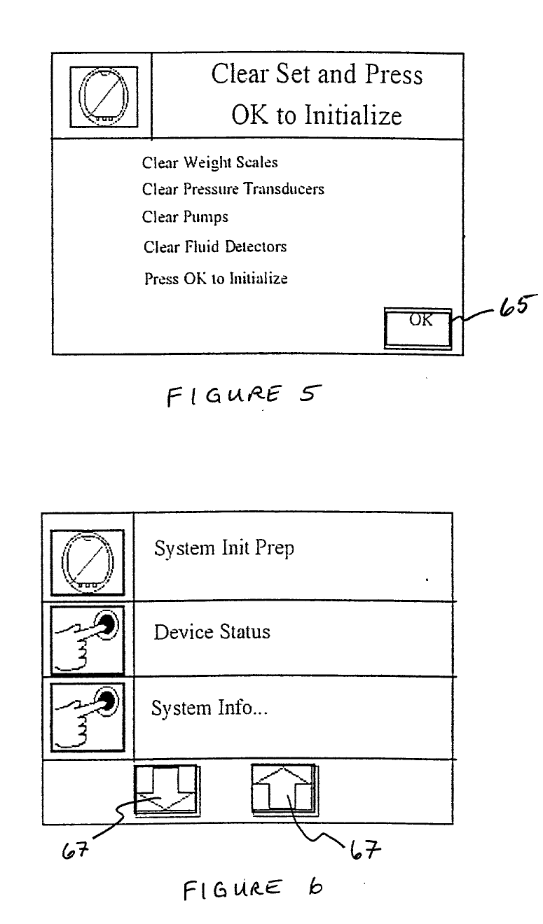

The “Menu” screen, of which a representative example is illustrated in FIG. 6, lists the highest level screens available to the user based on the state of the procedure. As previously described, the “Menu” screen is the screen that is displayed when a user selects or touches the “State” icon. The “Menu” screen and various other screens of the device 10 of the present invention include up and down arrow buttons 67. These buttons may be used to view additional system options or commands. Examples of these options include, but are not limited to, resume, process help, restart machine and system shutdown. In other cases, the selection of one menu option will result in a lower level display screen facilitating user input on specific parameters relevant to that menu item.

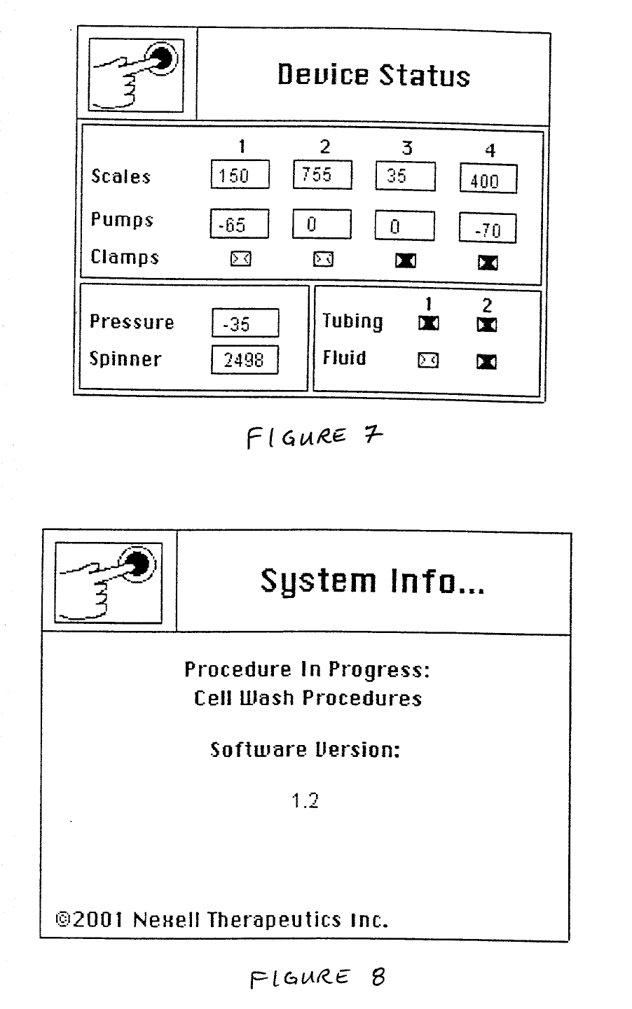

The “Device Status” screen provides information on pressure readings, spinner rotation rates, pump rates, scale weights, clamp status, fluid detector status, tubing status and fluid status. One example of a “Device Status” screen is illustrated in FIG. 7. In general, the “Device Status” screen may be accessed throughout the cell washing and fluid transfer procedure.

FIG. 8 illustrates a representative example of a “System Info . . . ” screen. This screen provides the user with information on the currently selected procedure and the software version installed in the device 10. If a procedure has not been selected, the procedure in progress will indicate none.

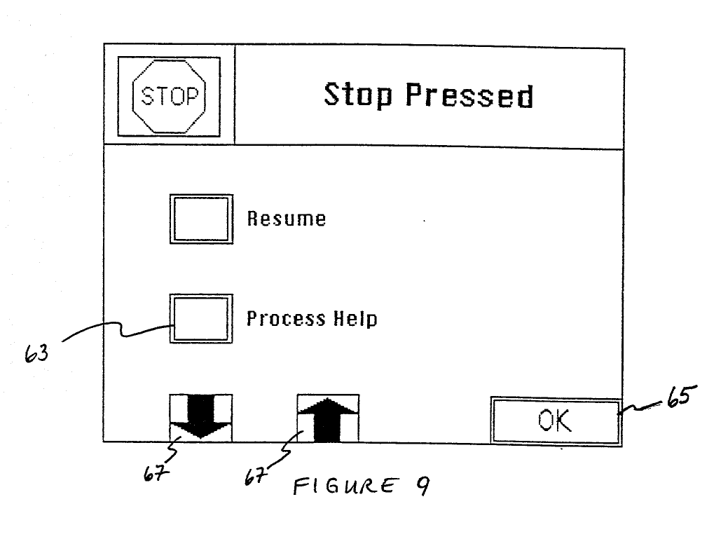

FIG. 9 illustrates a representative example of the “Stop Pressed” screen. When the “STOP” button is pressed on the keypad of the device 10, the pumps and spinner are stopped, the clamps are closed and the “Stop Pressed” screen appears on the display. In one embodiment of the invention, the stop key is located on the keypad of the device, independent of the user interface software. This configuration provides an added safety feature that allows a user to access the stop function at any time during device operation.

A “Process Help” button 63 may be included on the “Stop Pressed” screen. This Help key 63 is accessible throughout all procedures performed on the device and may aid in minimizing operator error, similar, for example, to conventional help icons on personal computers. Furthermore, the Help feature may provide automated assistance or step-by-step guidance to facilitate certain functions such as purging air from the wash circuit.

The system 10 of the invention provides continual monitoring of the process via the pressure transducers 18, fluid detectors 20 and weight scales 26. These sensors verify that the commanded operations are completed and, through communication with the system control module, detect conditions which differ from the expected program outcome and/or present potential process problems. For example, the system 10 will detect unusually high pressure if commanded to pump against a closed clamp. Another example involves the delivery of a specific volume of fluid to be transferred, wherein that particular volume is not present in the source container. In this situation, the system 10 will detect the inability to deliver the commanded volume based on a lack of weight decrease/increase on the source/destination scale. Under such conditions, the system 10 is designed to cease operation, sound an alarm and present an error message on the display. These error messages may indicate the nature of the condition which generated the alarm (e.g., high pressure) and offer suggested actions which may resolve the condition (e.g., check fluid pathway for obstruction). This process surveillance or monitoring minimizes operator error and its potential consequences. This is especially important when a user has designed a custom program for a unique process. System monitoring and related error messages also minimize the opportunity for a user to program impossible sequences and provide a method of resolution for unexpected circumstances.

### Method of Use

In addition to providing interactive system status displays, the user-interface module 12 of the present invention also provides default and custom programming options to device users. The default programs are preprogrammed into the system and include sequences of operations which are used to perform a variety of cell processing functions. Unlike default programs, custom programs (i.e., new programs) are individually designed and entered into the system by a user of the device 10. As such, each fluid processing command and series of operations can be uniquely tailored to accomplish any type of desired cell processing procedure. In addition, the device 10 also enables users to customize the standard or default programs, thereby providing an alternate method of creating novel user-defined programs. In one embodiment of the invention, a maximum of thirty steps can be entered into each custom program, with a total device memory capability of one hundred programs. Alternative embodiments of the device 10 do not include these programming limitations. As such, the programming capabilities of the device 10 of the present invention provide increased flexibility to the user by enabling the user to generate a variety of custom cell processing procedures. Furthermore, these programming capabilities, together with the automated features of the device 10, improve cell processing quality, reliability and repeatability, resulting in increased recovery of viable cells.

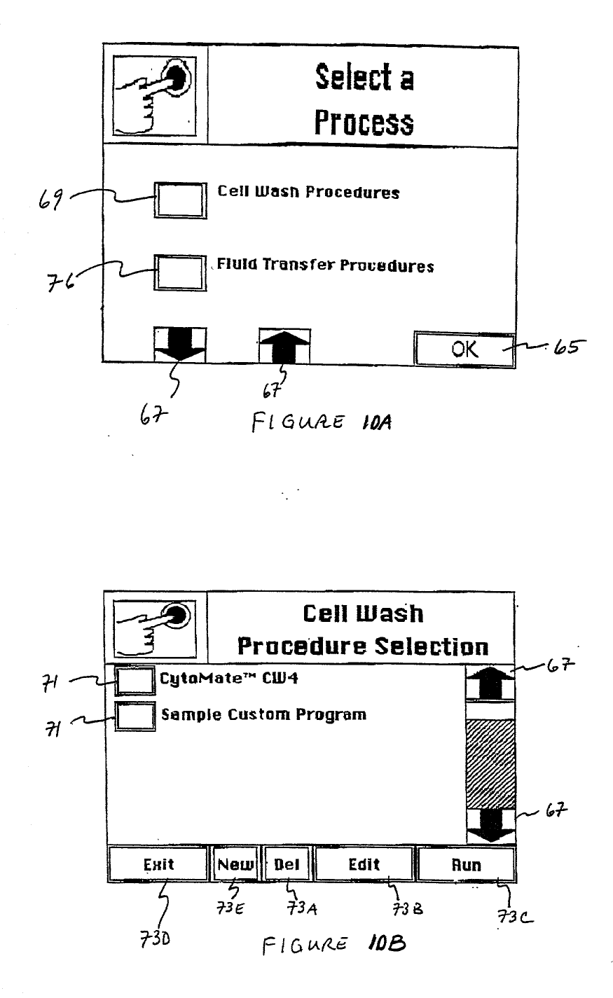

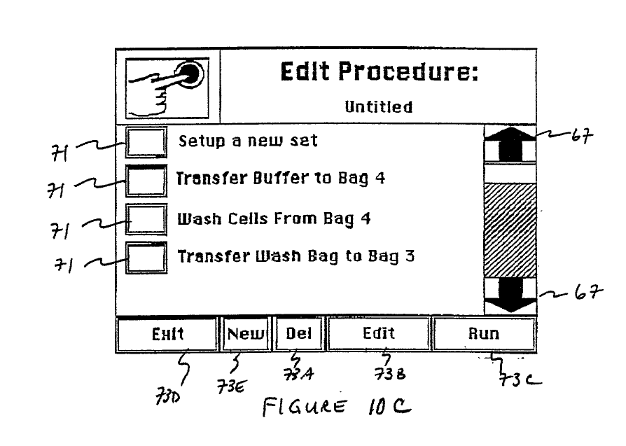

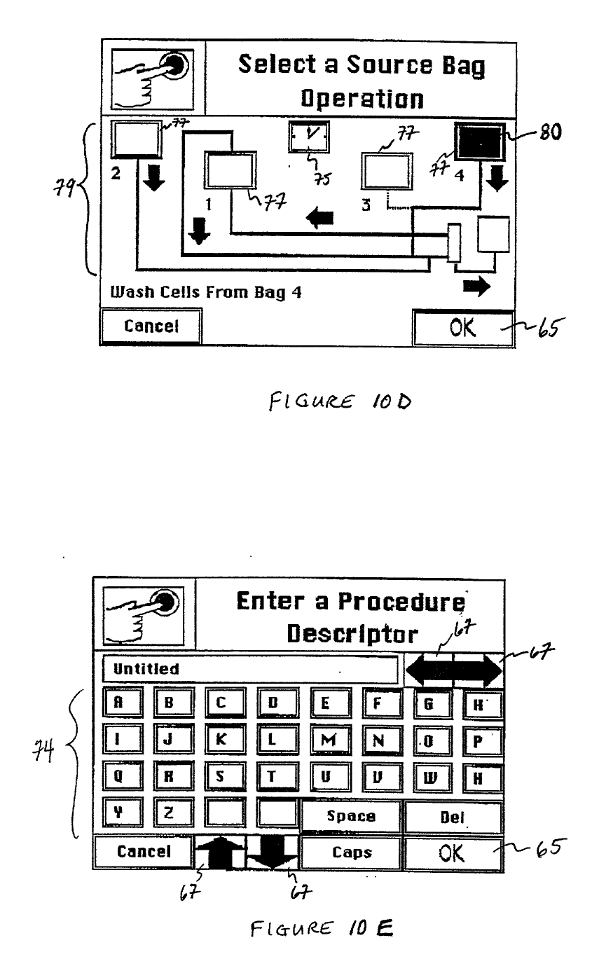

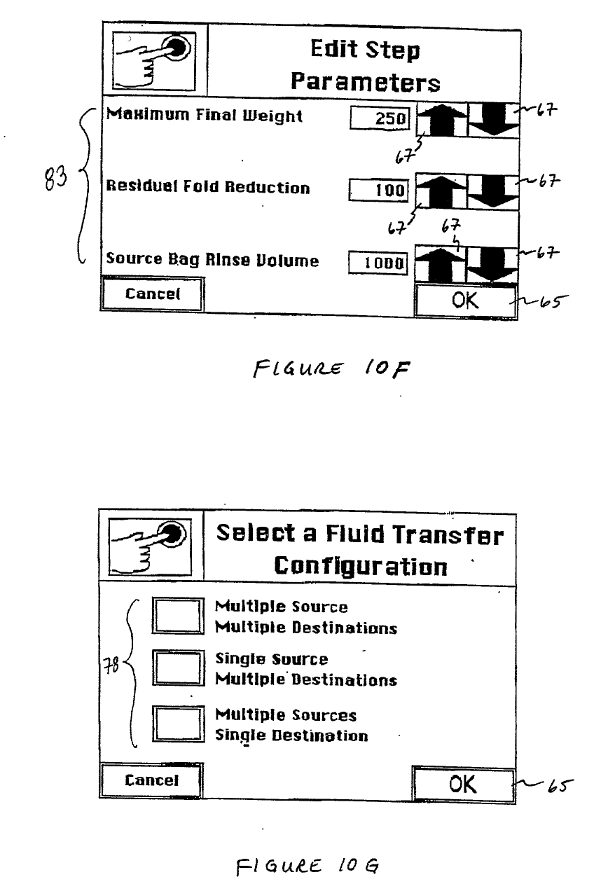

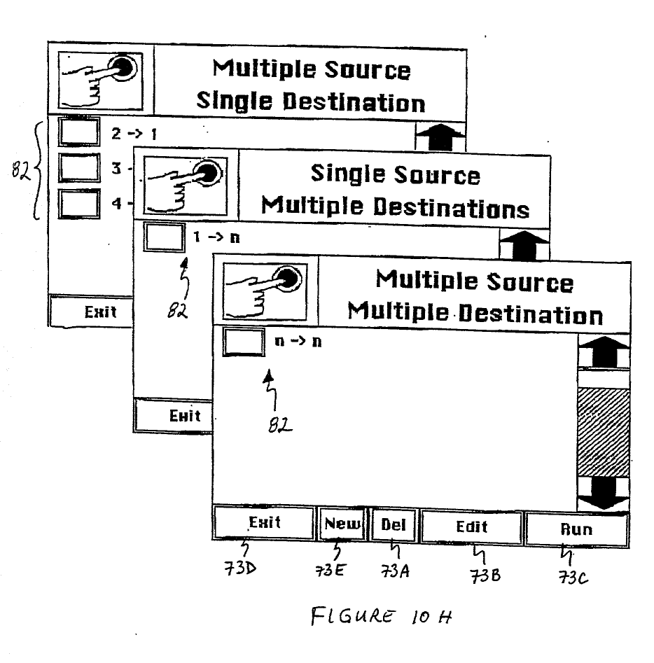

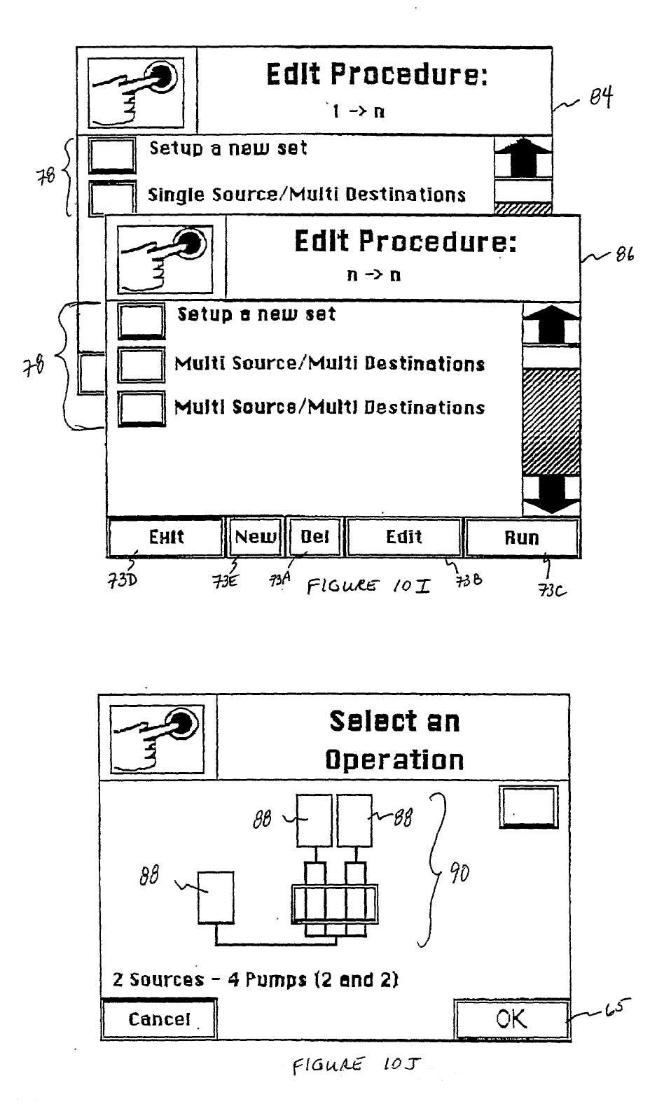

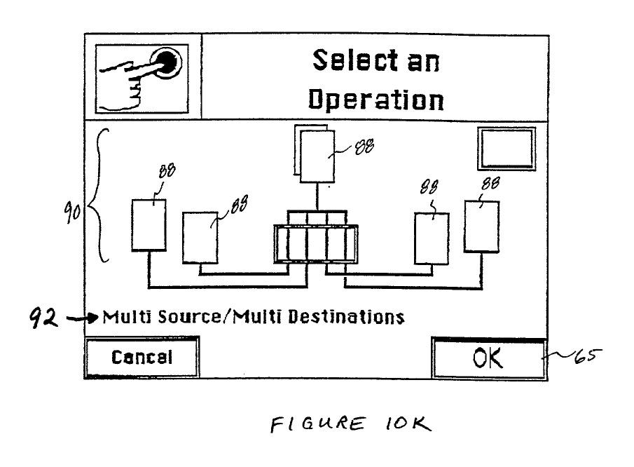

FIG. 10A illustrates one embodiment of a ‘Select a Process’ screen. This screen may be displayed, for example, after system initialization. The user selects the desired process type (e.g., “Cell Wash Procedures” or “Fluid Transfer Procedures”) via the touch screen. Based on the user choice, various sub-menus will be displayed indicating the programs or options available for the selected process type. For example, if a user wishes to perform a cell washing procedure, the user selects the “Cell Wash Procedures” button 69 and “OK” 65 to confirm the selection. The system 10 will then advance to the “Cell Wash Procedure Selection” screen, illustrated in FIG. 10B, which displays the various procedures 71 and functions 73 available to the user. The user may then select a saved procedure 71 and choose to delete 73A, edit 73B or run 73C this program. Alternatively, the user may also choose to exit 73D this screen, which will return the user to the process selection, or may choose to create an entirely new 73E program. Any of these five options may be selected simply by choosing the appropriate ‘button’ on the screen.

FIG. 10C illustrates one embodiment of an “Edit Procedure” screen. This screen may be displayed when the user selects, for example, the “New” button 73E from the “Cell Wash Procedure Selection” screen. In general, the “New” button 73E in the “Cell Wash Procedure Selection” screen allows a user to generate a new program based on an existing default program. For example, after selecting a procedure and then touching the “New” button 73E on the “Cell Wash Procedure Selection” screen, the following steps or operations 71 may be displayed on the “Edit Procedure” screen: “Set Up a New Set, “Transfer Buffer to Bag 4,” “Wash Cells From Bag 4,” and “Transfer to Wash Bag 3.” From the “Edit Procedure” screen, the user may select one of the steps or operations 71 and choose to Delete 73A, Edit 73B or Run 73C this operation. Alternatively, the user may also choose New 73E to create a new operation 71, whereby a new, user-defined operation 71 is inserted after or below the selected operation 71, or exit 73D the screen, whereby any changes made by the user can be saved by the system 10.

The “Run” button 73C on the “Edit Procedure” screen also provides for single-step debugging of procedures. Thus, after a user selects a procedure step or operation, the “Run” button 73C may be selected to evaluate the functionality of that particular operation. As such, this feature may facilitate the development and testing of custom programs. This feature may also be useful for step-wise execution of procedures or for completion or recovery from failed processes.

For Cell Wash processes, once a user has selected a program step and touched the “New” button, a new step is displayed after or below the selected step or operation. Alternatively, once a user has selected an existing program step and touched the “Edit” button, the “Select a Source Bag Operation” screen is displayed. FIG. 10D depicts one embodiment of a “Select a Source Bag Operation” screen of the present invention, wherein one clock 75 and four source options 77 are displayed on a representative fluid flow circuit 79. From this screen, the user may select the clock 75 (i.e., timer) or source 77 (i.e., bag or container) for the desired step and toggle through available options by repeatedly depressing the selected source button. The system will provide an indicator to denote the user's selection. An example of one embodiment of a system indicator 80 is illustrated in FIG. 10D. To confirm the selection and advance to the next screen or step, the user selects the “OK” button 65.

In general, the clock 75 and each source 77 include one or more steps or operations and related parameters. For example, the clock 75 may be selected to include one or more pause functions in a program. The pause function enables a user to suspend the procedure for a designated time period or to suspend the procedure until the user selects the “OK” button 65. In addition, a user may enter a message, displayed during execution of the pause function at run time, to future users of the program instructing on the specifics of manual intervention which may be required during or after the pause function. An example of a screen that may be used to enter program names or programmable text prompts is the “Enter a Procedure Descriptor” screen, illustrated in FIG. 10E. This screen may include an extensive character set 74 which includes capital and lower case letters, numbers, symbols and common characters used in European and other languages.

Alternatively, referring to FIG. 10D, if a user selects source “4,” the system will provide functions related to transferring media from source “4.” FIG. 10F illustrates one embodiment of a screen (i.e., “Edit Step Parameters” screen) displayed by the system 10 after “OK” 65 is selected.

As shown in FIG. 10F, the “Edit Step Parameters” screen includes one or more parameters related to the selected operation that may be edited by a user of the device 10. For example, the operation “Wash Cells from Bag 4” (described in further detail below) includes three parameters 83: Maximum Final Weight, Residual Fold Reduction and Source Bag Rinse Volume. Default values for each of the parameters 83 will initially be displayed on the screen. The user may edit these values by using the up and down arrows 67 included on the display. After the parameters are entered, the user may toggle through the various screens to edit additional parameters or steps in the procedure, exit and save the new procedure or run the procedure.

Referring to FIG. 10A, if the user wishes to perform a fluid transfer procedure, the user selects the “Fluid Transfer Procedures” button 76 and “OK” 65 to confirm the selection. The system 10 will then advance to the “Select a Fluid Transfer Configuration” screen, illustrated in FIG. 10G, which displays the various procedures 78 available to the user. In one embodiment of the invention, the device 10 provides a selection of three types of fluid transfer options 78 designated as Multiple Source Multiple Destinations (i.e., MM), Single Source Multiple Destinations (i.e., SM) and Multiple Sources Single Destinations (i.e., MS). After a user selects the desired fluid transfer option 78, a screen providing one or more selectable options, relating to the number of source containers that will be used during the procedure, is displayed. FIG. 10H illustrates embodiments of these source options 82 and screens available for each transfer procedure 78.

Similar to the previously described cell washing procedure, the fluid transfer procedure also includes an “Edit Procedure” screen. This screen may be displayed when the user selects a source option 82 and then either the “Edit” button or “New” button from one of the previously described screens. FIG. 101 illustrates an embodiment of a SM “Edit Procedure” screen 84 and a MM “Edit Procedure” screen 86.

For fluid transfer processes, once a user has selected a source option 82 or entered “New,” the “Select an Operation” screen is displayed. FIG. 10J depicts one embodiment of a “Select an Operation” screen for MS procedures, wherein the available sources 88 are displayed on a representative fluid flow circuit 90. From this screen, the user may select the source 88 (i.e., bag or container) for the desired step and toggle through available options by repeatedly depressing the selected source button.

FIG. 10K illustrates an alternate embodiment of a “Select an Operation” screen for MM procedures. As in the previous embodiment, the available sources 88 are displayed on a representative fluid flow circuit 90, with a brief text description 92 of the system set-up displayed below.

At any point within the above-described programming sequences for either cell washing of fluid transfer procedures, the user may select exit. The user will then be given options to save the program, save it to a new file or delete the changes made. The user may title the program as desired using the touch screen and an interface, such as that illustrated in FIG. 10E. The device may also include password control to protect the files from unauthorized changes or unauthorized access to procedures, thereby further minimizing the potential for operator error.

### Cell Washing Method of Use

In general, there are certain operations or functions that are common to cell washing procedures. The system 10 of the present invention enables users to vary and/or tailor these operations to better suit the user's processing needs. Cell washing in general includes the separation of cells from the fluid component of the suspension. This enables the cell product to be re-suspended in fresh fluids. Frequently this is done to remove spent material or reagents used for a previous process which are not desirable for subsequent operations. All known cell types may be washed using the present invention; the embodiment illustrated here includes a spinner membrane of approximately 4 microns. This is suitable to retain all white cells and preferentially remove platelets and cell fragments. In alternative embodiments a different membrane size might be used, for example sub-micron, to retain all red cell elements. Washing cells is universally important in cell processing. Examples of the needs include, but are not limited to: removal of culture media after a culture step, deglycerolization of red cells prior to infusion, removal of cryoprotectant post thaw prior to reinfusion, removal of free antibody after an antibody incubation but before a cell separation process.

Another feature of the invention is the inclusion of the ability to include a user defined circulation step. Using this operation the cell product is circulated through the filtered wash container, the spinner and connected tubing, however, fluids are not removed. This feature may be used to incorporate incubation steps in a cell process. During incubation an agent is added to the cell product and incubated for some period. The cells make ‘take up’ the agent or become modified in some other way based on the agent used. Mixing is important during these operations in order to facilitate contact between the cells and the agent. Examples of the uses of such an incubation include, but are not limited to: exposure of cells to antibodies which facilitate subsequent separation, exposure of cells to a red cell lysis agent which enables lysis and subsequent removal of red cells where they are not desired.

Washing cells is typically considered when the cells are the final product and the fluid removed is waste. However, the invention also includes the ability to separate cell suspensions or other particles of appropriate size for the spinner membrane used from fluid. There are applications where the supernatant fluid is the desired component and the cells are waste. It is clear that the described invention includes this capability simply by retaining the supernatant fluid as the final product. Examples of applications where this is desirable include, but are not limited to, harvesting the metabolic product of hybridoma cultures, and harvesting plasma from whole human blood.

While the embodiment described includes the washing of cells, it is clear that the invention has applications outside the cell processing arena. The device has capability, for example, to separate particles from fluid suspension. The separation may be achieved for various particle sizes based on the membrane pore size used. The device may also be used in any circumstance where particles are to be removed from fluid, either for purification, where the particulates represent ‘contamination’ (e.g., removal of incompletely dissolved solutes, purification of water), where it is desired to wash particles (e.g., chemical analytical methods) or where the particle is rare and concentration from fluid material is desired (e.g., enrichment of particles for identification may increase success due to assay sensitivities). Additional applications not specifically described herein but known to those skilled in the art are also included within the scope of the claimed invention.

The system 10 of the present invention enables users to define custom sequences of operations and vary underlying parameters, including, but not limited to, volume moved, time periods, addition of fluid, removal of fluid and pump rates. This is accomplished via program options. Examples of these options or operations include, but are not limited to, the following: “Set Up a New Set,” “Wash Cells,” “Circulate Wash Bag,” “Transfer Buffer,” “Transfer to Wash Bag,” “Pause,” and “Transfer Wash Bag.”

One common operation of all cell washing procedures is to install a new, cell washer tubing set 28 and associated bags or fluid containers onto the device 10. This operation, termed “Set Up a New Set,” must always be the first step in a wash procedure. The device 10 automatically verifies that the tubing set 28, spinning membrane 32, wash bag 34, buffer bag 42 and supernatant product bag 40 have been properly installed on the device 10 and automatically primes the tubing set 28 and bags using the wash solution.

The “Wash Cells” operation washes the cells in the designated bag based on the selected wash parameters. In general, the system includes three choices or options for cell washing. The first option, “Wash Cells from Bag 4” operation, is the most commonly used wash option and is chosen to begin the wash process on the starting cell product in the source bag 46/bag 4. The system 10 continues to concentrate and wash the cells from bag 4 until the fluid detector 20 determines that bag 4 is empty. At that time, wash buffer is pumped back into the source container 46 to flush the bag and then pumped back into the wash circuit. The washing continues based on user-defined wash parameters (e.g., maximum final weight; residual fold reduction, source bag rinse volume, etc.). A second commonly used wash option is “Wash Cells in Wash Bag.” The “Wash Cells in Wash Bag” option is chosen when the cell product is already in the wash bag 34 and needs subsequent washing. A third wash option, “Wash Cells from Bag 3,” is analogous to using bag 4 (described above). However, this option is chosen when line 3 is being used for purposes other than connection to a final product container.

Upon selection of any of the three wash cell operations or procedures described above, the device 10 will then prompt the user to define the wash parameters to be used. Examples of wash parameters include Maximum Final Weight, Residual Fold Reduction and Source Bag Rise Volume.

The Maximum Final Weight indicates the greatest weight of the wash bag at the end of the process. In one embodiment of the invention, this parameter may be selectable from 20 mL to 250 mL. A value of 250 mL may be chosen as a default setting. In practice, the actual volume may be significantly lower. The value selected by the user will be used as one parameter to determine completion of the washing process.

The Residual Fold Reduction parameter defines the degree of wash, e.g., the extent to which the original fluid is removed during the wash procedure. In one embodiment, this parameter may be selectable from one (1) to one-thousand (1000). A nominal value of 100 may be chosen as a default setting. This value may be appropriate for many generic washing processes and may result in approximately 2-log reduction of the source solution. The value selected by the user may be used as one parameter to determine completion of the washing process. Selection of the value one (1) will result in concentration only; the volume of the source product will be reduced but still suspended in source solution. Increasing the value above one-hundred (100) may be desirable in cases where it is extremely important to remove material included in the source solution. Selection of the value one-thousand (1000) may result in an approximately 3-log reduction of the source solution.

The Source Bag Rinse Volume parameter defines the amount of wash buffer that will be used to rinse the source container after it has been drained. In one embodiment, this parameter may be selectable from zero (0) to five-thousand (5000). A nominal value of forty (40) may be chosen as a default setting. This value may be appropriate for many applications. A greater volume may be desired, for example, in cases where a larger rinse is preferred. A smaller volume may be selected, for example, where a rinse is not deemed important.

It should be noted that the values for the various parameters referenced above are meant to be illustrative only and not limiting. Other values apparent to those of ordinary skill in the art are also included within the scope of the presently claimed invention.

The “Circulate Wash Bag” operation circulates the cell product in the wash bag 34 through the wash circuit based on various selected options. This operation is used when it is desired to mix the cell product with an added biological agent (e.g., incubation).

A Timer option (i.e., Circulate Wash Bag Timer) may also be selected which enables the custom program to automatically sequence to the next step without user interaction once the selected time has expired. Alternatively, a No Timer option (i.e., Circulate Wash Bag No Timer) may be chosen which prevents the custom program from sequencing to the next step until the user manually initiates the next step in the program sequence.

The “Transfer Buffer” operation enables the system to transfer buffer from the buffer bag 42/bag 2 into any of the other four bags (e.g., bags 1, 3, 4 and supernatant). This operation also provides default and user-defined parameters, such as buffer volume and maximum pump rate. Examples of when this operation may be selected include, but are not limited to, situations where it is desirable to dilute the starting product with buffer prior to initiating a wash process, to prime or flush a line with a volume of buffer, to dilute a starting or final product with buffer or to dilute the collected supernatant with buffer. In addition, by coupling other reagents to this line, it is possible to add any desired reagent to the system using this operation. For example, this operation may be used to add incubation agents to the cell product for use in the “Circulate Wash Bag” operation as described above, or it may be used to add solutions for re-suspension of a final cell product.

In one embodiment of the invention, the system 10 provides four buffer transfer options. The first option may be to “Transfer Buffer to Wash Bag.” This operation may be selected in cases where a secondary solution was included on line 2 (e.g., buffer bag 42) with the intention of using this solution during a circulation step (e.g., the biological agent for incubation would be transferred from the bag on line 2 to the cell product in the wash bag using this operation).

The second option for buffer transfer may be to “Transfer Buffer to Bag 4.” In many cases, this operation may be selected as the step immediately following the “Set Up a New Set” procedure. The “Transfer Buffer to Bag 4” operation will prime the tubing to Bag 4 and Bag 4 itself (i.e., cell source) with the designated volume of wash solution. This operation may be helpful in cases where it is desirable to dilute the starting product with wash buffer prior to initiating the wash process (e.g., cryopreserved product).

The third option for buffer transfer may be to “Transfer Buffer to Bag 3.” This operation should be selected in cases where it is desirable to dilute the final product in bag 3 with wash buffer or suspend it in a secondary line 2 source solution (e.g., the suspension of cell product in media prior to culture).

The fourth and final option for buffer transfer may be to “Transfer Buffer to Supernatant Bag.” This operation may be selected in cases where the supernatant is being saved (e.g., platelets, retroviral supernatant) and it is desirable to further dilute the collected supernatant with a solution from line 2.

The “Transfer to Wash Bag” operation provides the user with the capability of transferring the contents of the bags connected to lines 3 and 4 (e.g., the final product bag 44 and the source bag 46, respectively) to the wash bag 34. Although this operation is not commonly used, there may be instances when it is desirable to transfer, for example, source fluid to the wash bag.

The “Pause” option enables the user to pause system operation during a procedure. In one embodiment, the user may select a specific time interval or period for the pause. As such, the system will pause operation for the defined period of time. After the time period expires, the system will automatically resume operation. In an alternate embodiment, the user may program the system to pause and not resume operation until the user manually re-initiates system operation (for example, by depressing the OK button or icon).

The “Transfer Wash Bag” operation transfers washed cells to either bag 3 or bag 4. Bag 3 is generally chosen to transfer the washed cells to the final product bag 44 on line 3. Similarly, bag 4 is chosen to transfer the washed cells to the source container 46. Tubing rinse volumes and pumping rates may also be programmed by the user during this operation to customize the volume of fluid used and rate at which the transfer progresses.

### Default Cell Washing Procedure

As previously described, the cell processing and fluid transfer system 10 of the present invention provides both default and custom programming options to device users. To use a default program on the cell processing and fluid transfer apparatus 10 of the present invention, a user simply selects the desired procedure displayed on the “Select a Process” screen, as shown in FIG. 10A. The default procedure for cell washing, as defined by the device 10 of the present invention, uses a preprogrammed sequence of operations that includes four primary fluid transfer steps or processes.

In general, the first operation of the default cell wash procedure is “Set Up a New Set.” As described above, this operation instructs the user to install a new, cell washer tubing set 28 and associated bags or fluid containers onto the device 10. One example of a circuit diagram illustrating the installed components and system set-up is shown in FIG. 11. After set-up or installation is complete, the device 10 will verify that the tubing set 28 and other components have been properly installed and automatically will prime the various components with fluid. During the fluid prime, the system will also automatically obtain reference weights for each of the bags.

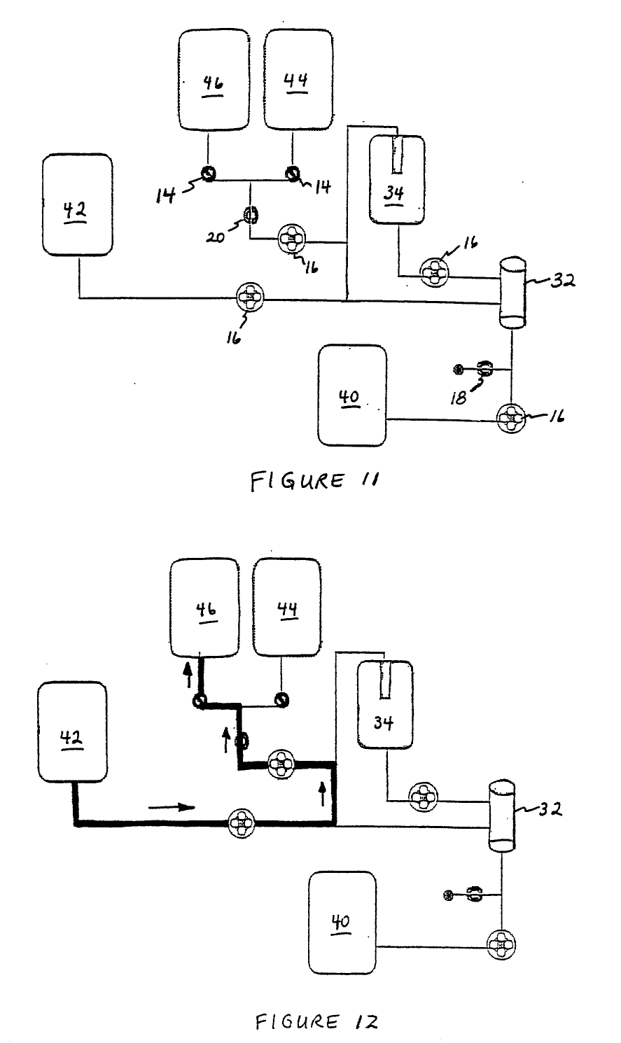

The next operation of the default cell wash procedure is “Transfer Buffer to Bag 4.” During this process, shown in FIG. 12, buffer from the buffer bag 42/bag 2 is pumped to bag 4 (i.e., the source bag 46 containing cells to be washed) until the desired volume of fluid is in bag 4. In one embodiment, user-defined buffer volume and maximum pump rates may be entered into the system 10 by a user of the device. Alternatively, the user may simply use the preprogrammed, default buffer volume and pump rates. One example of a default buffer volume is 35 grams (as measured on the device weight scales 26) and a default maximum pump rate is 100 mL/min.

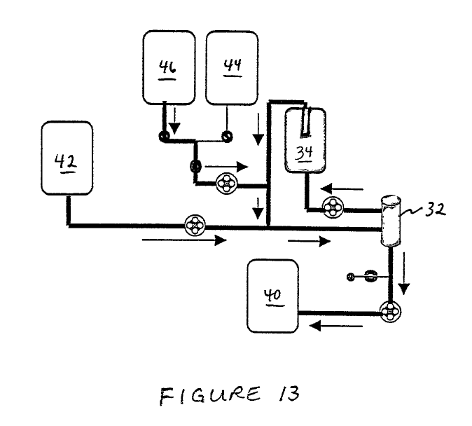

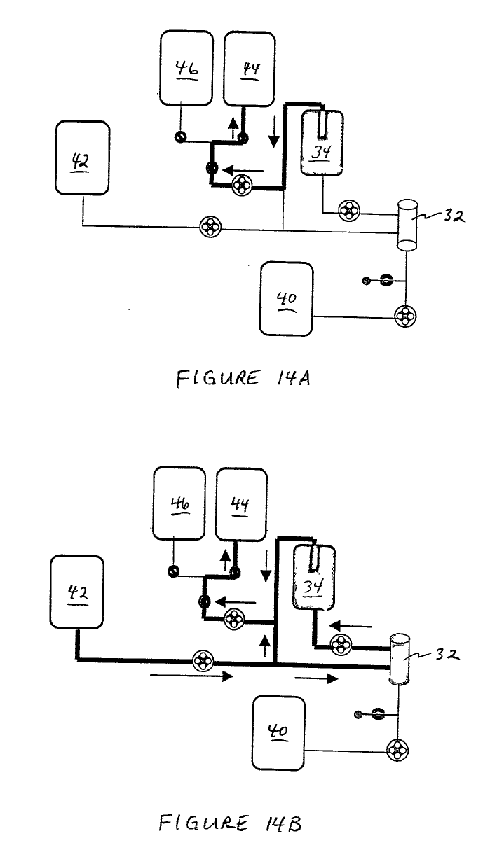

After buffer is transferred to the source bag 46/bag 4, the cells are then washed via the “Wash Cells from Bag 4” operation, illustrated in FIG. 13. Fluid from Bag 4 is pumped into the wash circuit across the spinning membrane 32 and into the filtered wash bag 34 of the device 10. As the cells are concentrated during their movement across the spinning membrane 32, the supernatant is pumped through the filter at a rate controlled or based on pressure readings across the spinning membrane 32. As the cells are drawn across the spinning membrane 32, the wash solution in the buffer bag 42 is added to dilute the cells as required based on the pressure readings. When all the cells are transferred from the source bag 46, the wash continues as described, except that the cells are circulated out of the filtered wash bag 34. Default or user-defined system parameters, such as maximum final weight, residual fold reduction and source bag rinse volume, further define the particular processes performed during the cell washing procedure.

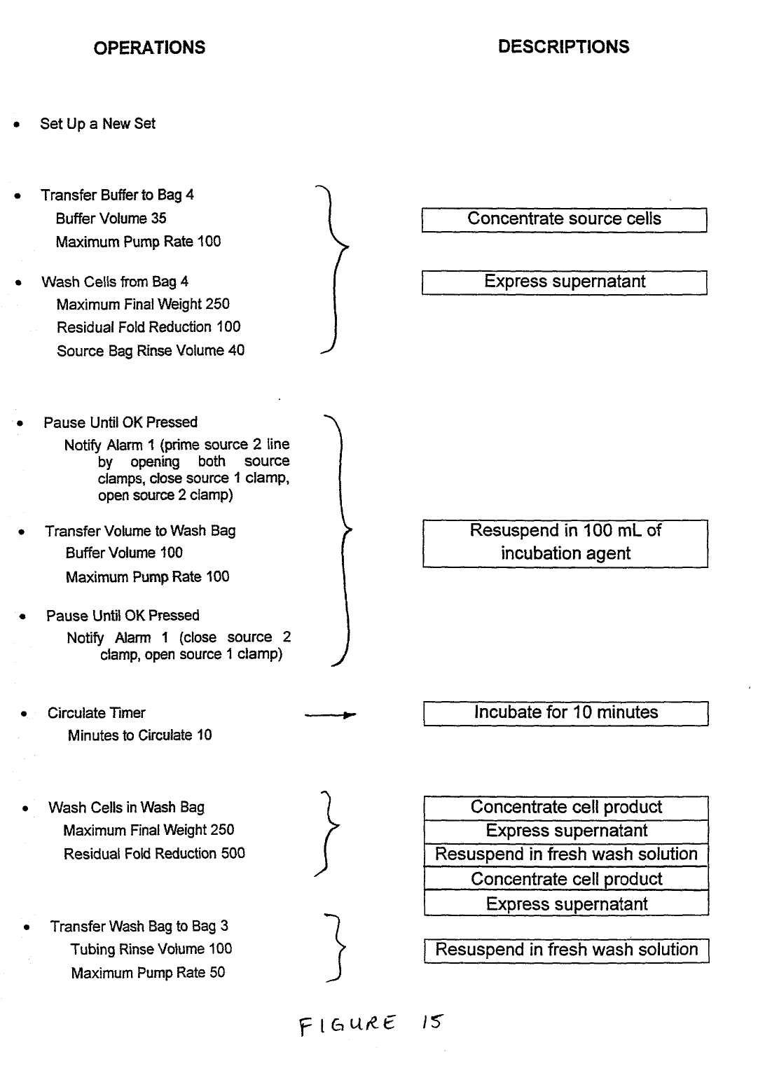

After the cells are washed, the cells are transferred to the destination or final product bag 44 via the “Transfer Wash Bag to Bag 3” operation. As shown in FIG. 14A, fluid containing the washed cells is pumped from the wash bag 34 to the destination bag 44 (i.e., bag 3). As shown in FIG. 14B, once the wash bag 34 is emptied, based on the weight of the filtered wash bag 34 and pressure in the tubing set 28, the bag 34 is rinsed with the solution in the buffer bag 40 through the spinning membrane 32. A majority of the rinse may be directed through the filtered wash bag 34 as illustrated. At this point, the cell washing procedure is complete. Additional operations performed by the user, such as heat sealing the lines to the bags, clamping the tubing, labeling the bags, disposing of waste product, etc., may be performed in accordance with standard laboratory protocols.

### User-Defined Cell Washing Procedure

A custom programmed or user-defined cell washing procedure may include many of the same steps as the previously described default cell washing procedure. However, custom programmed procedures commonly include one or more incubation phases and, thereby, utilize additional fluids during the procedure. To create a custom cell washing procedure, the user may either modify an existing or preprogrammed cell washing procedure or create an entirely new cell washing procedure.

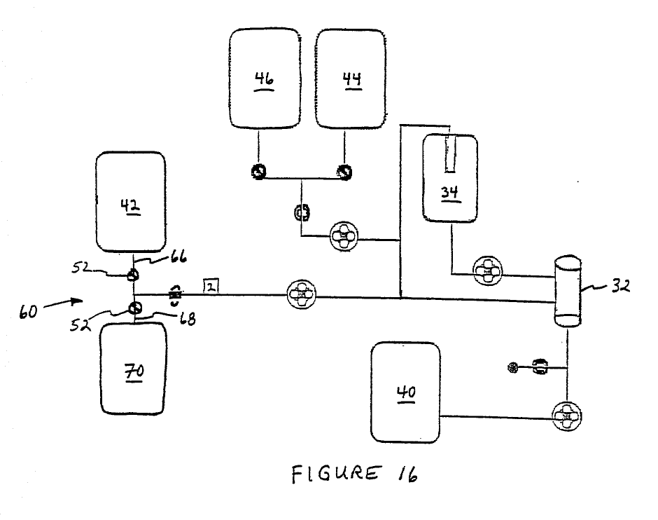

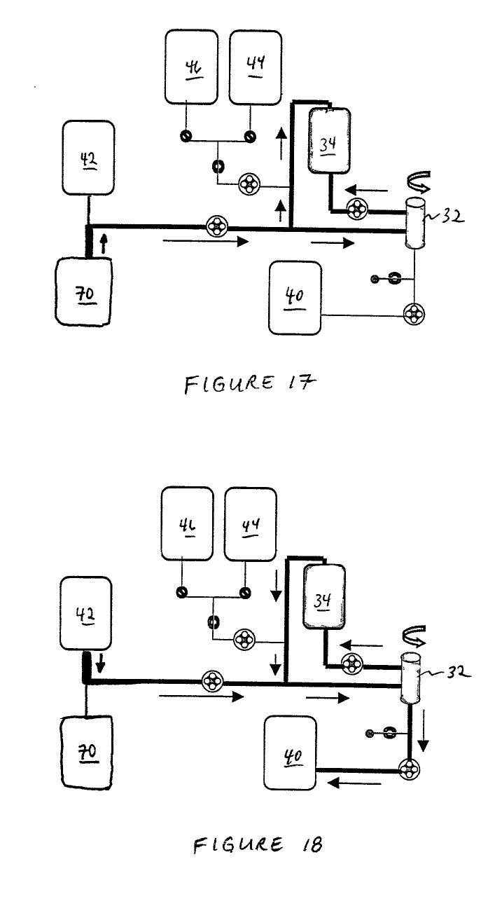

One example of a user-defined cell washing procedure, including a list of operations and associated descriptions, is illustrated in FIG. 15. As shown, the user-defined cell washing procedure may comprise the following nine steps: Set Up a New Set, Transfer Buffer to Bag 4, Wash Cells from Bag 4, Pause Until OK Pressed, Transfer Buffer to Wash Bag, Pause Until OK Pressed, Circulate Timer, Wash Cells in Wash Bag, and Transfer Wash Bag to Bag 3. An example of the fluid flow circuit of the system set-up for this particular custom programmed cell washing procedure is illustrated in FIG. 16. As shown in FIG. 16, line 2 of the cell washer tubing set 28 is connected to an adapter set 60. A first spike 66 of the adapter set 60 is connected to wash buffer 42 and a second spike 68 is connected to an incubation agent 70. One or more manual clamps 52 in fluid communication with the spikes 66,68 will be opened and closed when prompted during the procedure, as further described below.

The fluid transfers for the first three steps and the last step of the user-defined cell wash procedure are the same as those of the default program. However, five additional steps are added to the custom procedure. The “Pause Until OK Pressed” step of the custom program pauses the system and sounds a system alarm to notify the user that the procedure has been paused. During the system pause, the user closes the manual clamp 52 in fluid communication with the wash buffer and opens the manual clamp 52 in fluid communication with the incubation agent on line 2. After the user presses the OK button, the system automatically initiates the next step, “Transfer Buffer to Wash Bag,” of the custom procedure. FIG. 17 illustrates the fluid flow circuit of the “Transfer Buffer to Wash Bag” step.

Another “Pause Until OK Pressed” step is initiated on the system. During this second system pause, the user closes the manual clamp 52 in fluid communication with the incubation agent on line 2 and opens the manual clamp 52 in fluid communication with the wash buffer. After the user presses the OK button, the system automatically initiates the “Circulate Timer” step of the custom procedure. The fluid in the wash bag 34 incubates for a period of time specified by the user. Once the selected time has expired, the custom program automatically sequences to the next step without user interaction.

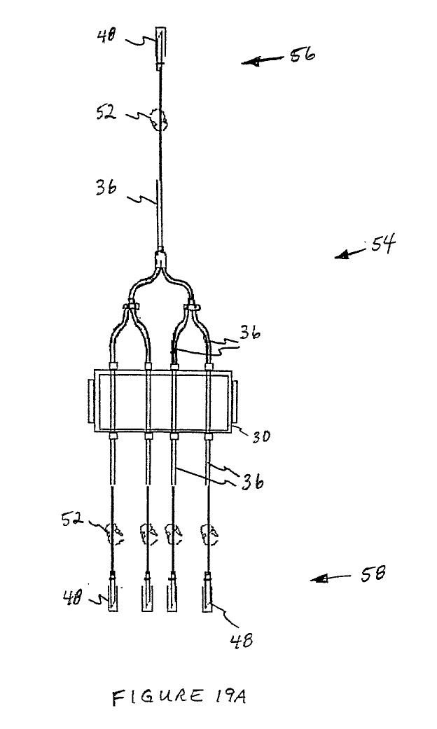

The “Wash Cells in Wash Bag” operation, illustrated in FIG. 18, is similar to the “Wash Cells from Bag 4” operation. The “Wash Cells in Wash Bag” operation is performed when the cell product or fluid is already in the wash bag and a secondary wash is needed. For example, to remove an incubation agent from a solution. The final step in the custom cell washing procedure is the same as the final step in the default program, whereby the washed cells are pumped to the final product bag 44.

To create a new cell washing procedure, the user selects the “New” button or icon on the bottom of the “Cell Wash Procedure Selection” screen (shown in FIG. 10B). Next, the user enters the desired series of new step(s), including system parameters, for the custom cell washing procedure. This custom programming feature of the present invention provides a user with great system flexibility and enables a user to generate an infinite number of user defined cell processing procedures. Furthermore, the fully automated system of the present invention reduces the potential for human error and, thereby, improves the quality, reliability and repeatability of the cell processing procedure, resulting in increased cell recovery.

### Fluid Transfer Method of Use

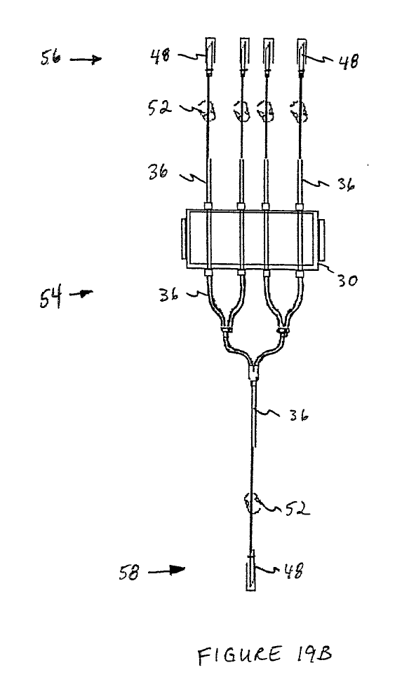

In addition to default and custom cell washing procedures, the device 10 of the present invention also includes default and custom fluid transfer procedures. The fluid transfer tubing set 54 is used for these fluid transfer applications. In general, three types of fluid transfer procedures are provided by the system. These procedures include: Multiple Source Lines to Multiple Destinations (i.e., MM), Single Source Line to Multiple Destinations (i.e., SM), and Multiple Source Lines to Single Destinations (i.e., MS). FIGS. 19A and 19B illustrate tubing set embodiments that may be used for the SM, MM and MS.

Referring to FIGS. 19A and 19B, one embodiment of the fluid transfer tubing set 54 includes four spike couplers 48 which connect to user defined containers. The four lines or tubing 36 pass through a pump frame and are joined together to provide one spike coupler 48 on the other end of the tubing set 54. This tubing set 54 may be used with the four spike ends pointing down, or the tubing set 54 may be rotated 180° for use with the four spikes pointing up towards the top of the device 10. The orientation chosen will depend on the desired operation.

For example, referring to FIG. 19A, for a MM operation, the tubing set 54 is installed on the device 10 with the four spikes 48 at a second/destination end 58 of the tubing set 54 pointing down (i.e., toward the bottom of the device 10). The single line 36, at a first/source end 56 of the tubing set 54, pointing up (i.e., toward the top of the device 10) may be adapted for multiple source containers through the use of an adapter set 60, as previously described. In one embodiment, the device 10 processes one source to all designated destinations simultaneously. Additional source solutions would be processed sequentially. The system 10 may determine the number of pumps to use based on the number of scales on which a destination bag has been installed.

A SM operation is similar to the MM operation described above. A repeat fill step may also be included during this operation.

For a MS operation, the tubing set 54 is installed with the four spikes 48 of a first end 56 of the tubing set 54 pointing up, as shown in FIG. 19B. The spikes may be connected directly to the source containers or via an adapter 60. This embodiment of the device includes the flexibility to combine various source numbers over various pumps to custom configure the system for greatest flexibility and efficiency. When using this feature, the tubing set configuration should match the chosen fluid pathway layout illustrated on the device display. The single line 58 of the tubing set 54 is used for connection to the destination bags. During this operation, the device 10 may pump all sources sequentially to one destination. If more than one destination bag is required to be filled, the additional destination bag(s) may be attached through the use of an adapter set 60.

During a fluid transfer operation, all source containers should be hung on the solution tower 24 and all destination containers must be hung on a scale 26. The system delivers the programmed volume from the source container(s) to the destination container(s) based on the increasing weight of the destination bag.

Certain operations and selectable parameters are common to all fluid transfer procedures. Closed system fluid transfer is a common requirement for many cell processes. Examples of these processes include, but are not limited to: initial seeding and set up of a culture, distribution of a product and cyroprotectant to numerous containers prior to freezing, separation and feeding of a culture and preparation of a medium or reagent which has multiple components for later use. The system 10 provides for flexibility to deliver different volumes of multiple materials into multiple destination containers. This is achieved via user selected program operations. Examples of these operations include, but are not limited to, “Set Up a New Set,” “Pause Until OK Pressed,” “Transfer Volume,” and “Maximum Pump Rate.”

The “Set Up a New Set” operation must always be the first step in any fluid transfer procedure. This operation instructs the user to install the tubing set 54 in the appropriate orientation for the chosen fluid transfer configuration. Additionally, the user is also instructed to connect the appropriate source and destination containers onto the system 10.

The “Pause Until OK Pressed” operation causes the process to stop until the user depresses the OK button. This operation prompts the user to indicate whether they want the system alarm to notify them that the pause step has been reached in the procedure. This operation is generally helpful when a user interaction is required during the fluid transfer process. A text message may also be entered into the system by the user and will appear on the screen when the pause state is reached. The text message may be used to prompt the user to perform a particular manual step in the procedure.

The “Transfer Volume” operation allows the user to select the desired volume of fluid to be pumped through the system. The user may also select or define the speed of fluid delivery or flow rate via the “Maximum Pump Rate” operation.

### Default Fluid Transfer Procedure

As previously described, the cell processing and fluid transfer system 10 of the present invention provides both default and custom programming options to device users. To use a default fluid transfer program, a user simply selects the desired procedure from the appropriate screens. The default procedure for a “multiple source lines to multiple destinations fluid transfer” (i.e., MM) procedure, as defined by the device of the present invention, uses a preprogrammed sequence of operations.

In general, the first operation of the default MM fluid transfer procedure is “Set Up a New Set.” As described above, this operation instructs the user to install a new, fluid transfer tubing set 54 and associated source and destination containers onto the device 10. If required, tubing adapters 60 may also be used to create additional fluid lines 36. The system will also prompt the user to open all manual clamps 52 leading to the destination and source bags.

After set-up or installation is complete, the device will begin the “Transfer Volume” operation of the fluid transfer procedure. Default parameters for target volume delivered and pump rate are used to further define the MM process. When the target volume has been delivered to each bag, the fluid transfer is complete. Additional operations performed by the user, such as heat sealing the lines to the bags, clamping the tubing, labeling the bags, disposing of waste product, etc., may be performed in accordance with standard laboratory protocols.

### User-Defined Fluid Transfer Procedure

A custom programmed or user-defined MM procedure includes many of the same steps as the previously described default MM procedure. However, custom programmed procedures may include one or more pause steps during the procedure. To create a custom MM procedure, the user may either modify an existing, preprogrammed fluid transfer procedure or create an entirely new fluid transfer procedure.

To modify an existing procedure, the user selects the “Edit” button or icon on the bottom of the procedure selection screen (shown in FIG. 10H). Next, the “Edit Procedure” screen lists the series of steps for the selected procedure. The user simply selects each step of the procedure to be modified and then edits the various system parameters associated with each step. For example, the default MM procedure comprises two steps: Set Up a New Set and Transfer Volume. This procedure may be modified to a custom, user-defined program by adding additional steps. As such, the resulting, user-defined MM procedure now comprises the following four steps: Set Up a New Set, Volume Transfer, Pause Until OK Pressed, and Volume Transfer. In addition, user-defined transfer volumes and pump rates may also be modified and entered into the system.

The additional steps added to the user-defined MM procedure allow the user to open and close various source and/or destination clamps 52 during a pause in the fluid transfer process. After the pause, fluid is once again transferred from the source bag(s) to the destination bag(s), although fluid paths may vary based upon clamp configuration of each line. After the desired volume has been transferred, the procedure is complete.

To create a new fluid transfer procedure, the user selects the “New” button or icon on the bottom of the procedure selection screen (shown in FIG. 10H). Next, the user enters the desired series of new step(s), including system parameters, for the custom fluid transfer procedure. This custom programming feature of the present invention provides a user with great system flexibility and enables a user to generate an infinite number of user defined fluid transfer procedures. Furthermore, the fully automated system of the present invention reduces the potential for human error and, thereby, improves the quality, reliability and repeatability of the fluid transfer procedure.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An automated method of processing particles in a fluid comprising:
entering one or more operations into an automated processing device, said operations including:
separating discrete particles in a suspension from a suspending fluid based on particle size;
washing said particles by concentration of said particles, removal of said fluid and resuspension in a second fluid;
mixing a particle suspension;
selectively adding and/or removing a secondary suspension from and to multiple integral containers;
pausing operations; and
receiving processing information from said automated device.

2. The method of claim 1 further comprising selecting a program to control performance of said operations.

3. The method of claim 1 further comprising creating a user-defined program to control performance of said operations.

4. The method of claim 2 further comprising editing said program to include user-defined operations.

5. The method of claim 3 further comprising editing said program to include user-defined parameters.

6. An automated fluid transfer device comprising:
a pump module; and
a disposable, sterile tubing set, said tubing set configurable on said pump module in a first configuration and said tubing set configurable on said pump module in a second configuration, wherein said second configuration is achieved by rotating said first configuration 180 degrees.

7. The device of claim 6 wherein said tubing set includes a first end having a single source line and a second end having multiple destination lines.

8. The device of claim 6 wherein said tubing set includes a first end having multiple source lines and a second end having a single destination line.

9. The device of claim 6 wherein said tubing set includes a first end having multiple source lines and a second end having multiple destination lines.
